(19) United States
(12) Patent Application Publication
(10) Pub. No.: US 2024/0289173 A1
(43) Pub. Date: Aug. 29, 2024

(54) TASK PROCESSING METHOD AND APPARATUS, DEVICE, AND MEDIUM

(71) Applicant: (INSPUR SUZHOU INTELLIGENT TECHNOLOGY CO., LTD.), Suzhou (CN)

(72) Inventors: Junfei Zheng, Suzhou (CN); Jiangbo Xu, Suzhou (CN); Wendao Mu, Suzhou (CN); Minggang Ren, Suzhou (CN)

(21) Appl. No.: 18/564,957

(22) PCT Filed: Apr. 28, 2022
(86) PCT No.: PCT/CN2022/089820

§ 371 Date: Nov. 28, 2023

(30) Foreign Application Priority Data
Nov. 12, 2021 (CN) 202111336113.5

(51) Int. Cl. G06F 9/50

(52) U.S. Cl. CPC G06F 9/5038; G06F 9/5016; G06F 9/5022; G06F 9/5088

(57) ABSTRACT

A task processing method includes: acquiring a plurality of to-be-processed tasks; the plurality of to-be-processed tasks corresponding to a plurality of buffer management request sets; creating different storage queues for storing information of different processing stages for each of the plurality of buffer management request sets to obtain a plurality of storage queue sets corresponding to the plurality of buffer management request sets; processing the plurality of to-be-processed tasks in parallel by hardware, processing different buffer management requests in the buffer management request sets in a pipeline parallel mode, and storing information of corresponding processing stages by utilizing different storage queues in the plurality of storage queue sets. By means of the aforesaid method, tasks are collaboratively processed by software and hardware, so that the performance of a buffer management algorithm is improved, and the speed of task processing is further increased.

The present application claims the priority of Chinese patent application No. 202111336113.5, filed to the CNIPA on Nov. 12, 2021, and entitled “task processing method and apparatus, device, and medium”, which is incorporated herein by reference in its entirety.

### TECHNICAL FIELD

The present application relates to the technical field of computers, in particular relates to a task processing method and apparatus, a device, and a medium.

### BACKGROUND

With the development of information technology such as artificial intelligence and Internet of Things, more and more intelligent hardware has emerged, and the amount of business data related to intelligent hardware has also increased exponentially, which makes the data transmission bandwidth gradually become a bottleneck that restricts the improvement of hardware performance. In order to increase the data transmission bandwidth, researchers have proposed many parallel data transmission framework protocols based on multi-channel Direct Memory Access (DMA), and the improvement of multi-channel DMA performance further relies on DMA buffer management strategies, so a set of efficient DMA buffer management strategies is needed to provide an effective data storage resource pool for multi-channel DMA data transmission.

At present, during task processing, firstly, a DMA buffer chain table is requested to be built for a DMA buffer pool, and then the DMA buffer pool is managed in a processor software by means of a certain buffer management algorithm such as a bitmap algorithm or an idle chain table algorithm. When the application program processes a data transmission task, the buffer management module of the processor software requests to allocate DMA buffers for all the DMA channels, fills data therein, and triggers all the channels to perform DMA transmission, and when the data transmission task is completed, the DMA buffers of all the channels are released by the buffer management module. The aforesaid buffer management algorithm is completely executed by a processor software, so a utilization rate of the processor is high, which adversely affects execution of application programs. Moreover, the software executes tasks in a serial mode, and the buffer management algorithm is executed in a synchronous mode, thus, when there are too many DMA channels, data transmission performance would have a bottleneck, therefore, the performance of the buffer management algorithm is relatively poor and the speed of task processing is relatively slow.

In conclusion, the problem is how to reduce the utilization rate of a processor, improve the performance of a buffer management algorithm and increase the speed of task processing.

### SUMMARY

In view of the above, it is an objective of the present application to provide a task processing method and apparatus, a device, and a medium, which are capable of reducing the utilization rate of a processor, improving the performance of a buffer management algorithm and increasing the speed of task processing. Specific technical solutions thereof are as follows:

In a first aspect, the present application discloses a task processing method that includes:
acquiring a plurality of to-be-processed tasks; wherein, the plurality of to-be-processed tasks respectively correspond to a plurality of buffer management request sets;
creating different storage queues for storing relevant information of different processing stages in a request processing process for each of the plurality of buffer management request sets to obtain a plurality of storage queue sets respectively corresponding to the plurality of buffer management request sets;
processing the plurality of to-be-processed tasks in parallel by a hardware device with parallel execution functionality, and in a process of processing any one of the plurality of buffer management request sets, processing different buffer management requests in the plurality of buffer management request sets based on a pipeline parallel processing mechanism, and storing relevant information of corresponding processing stages by using different storage queues in the plurality of storage queue sets.

In some embodiments, the step of creating different storage queues for storing relevant information of different processing stages in a request processing process for each of the plurality of buffer management request sets to obtain a plurality of storage queue sets respectively corresponding to the plurality of buffer management request sets comprises:
for each buffer management request set, creating a request queue for storing request information corresponding to a request acquisition stage, a page index queue for storing memory page index information relevant to a buffer configuration stage, and a response queue for storing response information corresponding to a request response stage, respectively, in the request processing process, to obtain the plurality of storage queue sets respectively corresponding to the plurality of buffer management request sets.

In some embodiments, after the step of processing different buffer management requests in the plurality of buffer management request sets based on a pipeline parallel processing mechanism, and storing relevant information of corresponding processing stages by using different storage queues in the plurality of storage queue sets, the method further includes:
judging whether the response queue is a non-empty queue;
in response to the response queue is a non-empty queue, then generating a new interrupt flag;
updating a preset interrupt flag register by using the new interrupt flag, so that, after a software program running in a central processing unit detects that an interrupt flag in the interrupt flag register is updated, obtaining response information corresponding to the new interrupt flag from the response queue, and performing corresponding processing based on the obtained response information.

In some embodiments, the step of processing the plurality of to-be-processed tasks in parallel by a hardware device with parallel execution functionality includes:
processing the plurality of to-be-processed tasks in parallel by the hardware device with parallel execution functionality, and during the process of processing the plurality of to-be-processed tasks in parallel, performing a load balancing operation on a page index queue of a target to-be-processed task, which meets a preset condition, based on a preset load balancing strategy.

In some embodiments, the step of performing a load balancing operation on a page index queue of a target to-be-processed task, which meets a preset condition, based on a preset load balancing strategy includes:
monitoring a plurality of page index queues corresponding to the plurality of to-be-processed tasks to select a target page index queue with currently unbalanced load, and triggering a to-be-processed load balancing event for the target page index queue;
monitoring whether there is currently a to-be-processed buffer configuration event for the target page index queue;
in response to a to-be-processed buffer configuration event is currently detected, then, according to a preset priority determination strategy, determining a first priority corresponding to the to-be-processed load balancing event and a second priority corresponding to the to-be-processed buffer configuration event;
in response to the first priority is higher than the second priority, performing a load balancing operation for the target page index queue, and then performing a buffer configuration operation for the target page index queue;
in response to the first priority is lower than the second priority, performing a buffer configuration operation for the target page index queue, and then performing a load balancing operation for the target page index queue.

In some embodiments, the step of performing a load balancing operation for the target page index queue includes:
in response to a memory page usage state corresponding to the target page index queue is an oversaturated state, allocating a new memory page for the target page index queue by using a preset page index cache queue and according to a preset memory page allocation strategy;
in response to the memory page usage state of the target page index queue is an idle state, then an idle memory page corresponding to the target page index queue is released according to a preset memory page release strategy to restore the idle memory page into the preset page index cache queue;
and, the step of creating a page index queue for storing memory page index information relevant to a buffer configuration stage includes:

determining a first preset memory page allocation proportion and a second preset memory page allocation proportion;
allocating a corresponding number of memory pages in a memory to a first queue according to the first preset memory page allocation proportion to obtain the preset page index cache queue, and allocating another corresponding number of memory pages in the memory to a second queue according to the second preset memory page allocation proportion to obtain the page index queue.

In some embodiments, the step of storing relevant information of corresponding processing stages by using different storage queues in the plurality of storage queue sets includes:
storing a callback function address corresponding to each of the respective processing stages by using different storage queues in the plurality of storage queue sets, for determining a current degree of processing progress of a processing stage by utilizing the callback function address corresponding thereto.

In some embodiments, the plurality of to-be-processed tasks respectively correspond to a plurality of buffer management request sets in such a way that:
the plurality of to-be-processed tasks respectively correspond to the plurality of buffer management request sets in a one-to-one manner.

In a second aspect, the present application discloses a task processing apparatus that includes:
a task acquisition module, configured to acquire a plurality of to-be-processed tasks; wherein, the plurality of to-be-processed tasks respectively correspond to a plurality of buffer management request sets;
a queue set creation module, configured to create different storage queues for storing relevant information of different processing stages in a request processing process for each of the plurality of buffer management request sets to obtain a plurality of storage queue sets respectively corresponding to the plurality of buffer management request sets;
a task processing module, configured to process the plurality of to-be-processed tasks in parallel by a hardware device with parallel execution functionality, and, in a process of processing any one of the plurality of buffer management request sets, process different buffer management requests in the plurality of buffer management request sets based on a pipeline parallel processing mechanism;
an information storage module, configured to store relevant information of corresponding processing stages by using different storage queues in the plurality of storage queue sets.

In some embodiments, the plurality of to-be-processed tasks respectively correspond to a plurality of buffer management request sets in such a way that:
the plurality of to-be-processed tasks respectively correspond to the plurality of buffer management request sets in a one-to-one manner.

In a third aspect, the present application discloses an electronic device that includes a processor and a memory; wherein, the memory has a computer program stored therein, and the computer program, in response to executed by the processor, causes the processor to perform the aforesaid task processing method.

In a fourth aspect, the present application discloses a computer-readable storage medium, configured to store a computer program therein; wherein, the computer program, in response to executed by a processor, causes the processor to perform the aforesaid task processing method.

It can be seen that, the present application acquires a plurality of to-be-processed tasks; wherein, the plurality of to-be-processed tasks respectively correspond to a plurality of buffer management request sets; creates different storage queues for storing relevant information of different processing stages in a request processing process for each of the plurality of buffer management request sets to obtain a plurality of storage queue sets respectively corresponding to the plurality of buffer management request sets; and processes the plurality of to-be-processed tasks in parallel by a hardware device with parallel execution functionality, and, in a process of processing any one of the plurality of buffer management request sets, processes different buffer management requests in the plurality of buffer management request sets based on a pipeline parallel processing mechanism, and stores relevant information of corresponding processing stages by using different storage queues in the plurality of storage queue sets. By means of the aforesaid technical solution, tasks are collaboratively processed by software and hardware, and most of the processing processes are completed by hardware, so that the use of software is decreased and a utilization rate of the processor is significantly reduced. In addition, the aforesaid technical solution uses a hardware device with parallel execution functionality to realize parallel processing of multiple tasks, and adopts a pipeline parallel processing mechanism to realize asynchronous processing of different buffer management requests in the plurality of buffer management request sets, thus improving the performance of a buffer management algorithm and increasing the speed of task processing.

### BRIEF DESCRIPTION OF DRAWINGS

In order to more clearly explain technical solutions in embodiments of the present application or in the prior art, the drawings that need to be used in description of the embodiments or the prior art are briefly introduced below. Apparently, the drawings described below only represent some embodiments of the present application, and other drawings can be derived from the provided drawings by a person skilled in the art without making creative efforts.

FIG. 1 is a flowchart of a task processing method disclosed by the present application;

FIG. 2 is a schematic diagram of a storage queue provided by the present application;

FIG. 3 is a schematic diagram of a task processing method provided by the present application;

FIG. 4 is a flowchart of a specific task processing method provided by the present application;

FIG. 5 is a schematic diagram of a task processing method provided by the present application;

FIG. 6 is a schematic structural diagram of a task processing apparatus provided by the present application;

FIG. 7 is a structural diagram of an electronic device provided by the present application;

FIG. 8 is a structural diagram of a computer-readable storage medium provided by the present application.

### DETAILED DESCRIPTION OF SPECIFIC EMBODIMENTS

A clear and complete description of technical solutions of the embodiments of the present application is given below in conjunction with the drawings in the embodiments herein, and it is apparent that the described embodiments only represent a part of the embodiments of the present application, not all of them. Based on the embodiments described in the present application, all other embodiments obtainable by a person skilled in the art without making creative efforts shall fall within the protection scope of the present application.

At present, during task processing, firstly, a DMA buffer chain table is requested to be built for a DMA buffer pool, and then the DMA buffer pool is managed in a processor software by means of a certain buffer management algorithm such as a bitmap algorithm or an idle chain table algorithm. In response to the application program processes a data transmission task, the buffer management module of the processor software requests to allocate DMA buffers for all the DMA channels, fills data therein, and triggers all the channels to perform DMA transmission, and in response to the data transmission task is completed, the DMA buffers of all the channels are released by the buffer management module. The aforesaid buffer management algorithm is completely executed by a processor software, so a utilization rate of the processor is high, which adversely affects execution of application programs. Moreover, the software executes tasks in a serial mode, and the buffer management algorithm is executed in a synchronous mode, thus, in response to there are too many DMA channels, data transmission performance would have a bottleneck, therefore, the performance of the buffer management algorithms is relatively poor and the speed of task processing is relatively slow. In order to overcome the aforesaid problem, the present application provides a task processing solution, which can reduce a utilization rate of a processor, improve the performance of a buffer management algorithm and increase the speed of task processing.

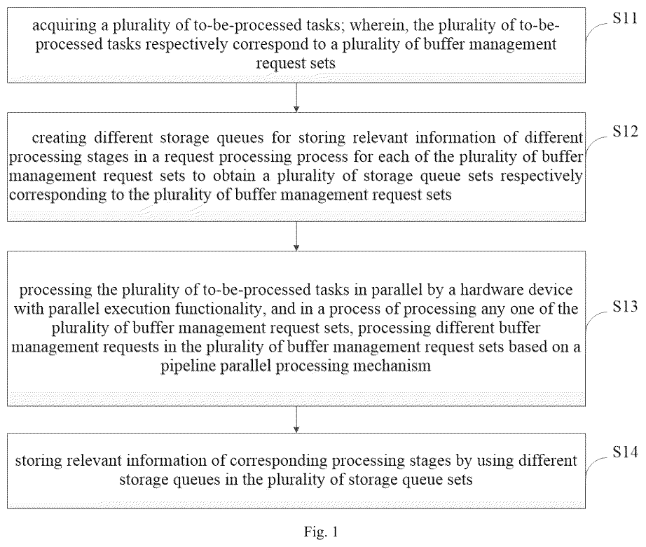

Referring to FIG. 1, an embodiment of the present application discloses a task processing method which includes:

Step S11: acquiring a plurality of to-be-processed tasks; wherein, the plurality of to-be-processed tasks respectively correspond to a plurality of buffer management request sets.

In this embodiment, software acquires a plurality of to-be-processed tasks, each of the to-be-processed tasks corresponds to one buffer management request set, the buffer management request set includes a plurality of buffer management requests, and a buffer management request may be a buffer allocation request or a buffer release request.

Step S12: creating different storage queues for storing relevant information of different processing stages in a request processing process for each of the plurality of buffer management request sets to obtain a plurality of storage queue sets respectively corresponding to the plurality of buffer management request sets.

In this embodiment, the step of creating different storage queues for storing relevant information of different processing stages in a request processing process for each of the plurality of buffer management request sets can be understood as, for any one of the plurality of buffer management request sets, creating a request queue for storing request information corresponding to a request acquisition stage, a page index queue for storing memory page index information relevant to a buffer configuration stage, and a response queue for storing response information corresponding to a request response stage, in the request processing process. The request queue, the page index queue and the response queue together constitute a storage queue set, therefore, one buffer management request set corresponds to one storage queue set. Correspondingly, creating different storage queues for storing relevant information of different processing stages in a request processing process for each of the plurality of buffer management request sets can obtain a plurality of storage queue sets respectively corresponding to the plurality of buffer management request sets. In some embodiments, after creating a plurality of storage queue sets respectively corresponding to the plurality of buffer management request sets, address and size information of all the queues are configured into hardware, and the hardware completes the process of processing a plurality of buffer management request sets corresponding to the plurality of to-be-processed tasks.

Step S13, processing the plurality of to-be-processed tasks in parallel by a hardware device with parallel execution functionality, and in a process of processing any one of the plurality of buffer management request sets, processing different buffer management requests in the plurality of buffer management request sets based on a pipeline parallel processing mechanism.

In this embodiment, the plurality of to-be-request tasks are processed in parallel by a hardware device having parallel execution functionality, which can be understood as, the hardware device starts to process the plurality of to-be-request tasks simultaneously. Moreover, multi-task parallel processing improves the performance of a buffer management algorithm and further increase the speed of task processing.

In this embodiment, each of the plurality of to-be-request tasks corresponds to one of the plurality of buffer management request sets, and each of the plurality of buffer management request sets contains a plurality of buffer management requests. In a process of processing any one of the plurality of buffer management request sets, processing different buffer management requests in the plurality of buffer management request sets based on a pipeline parallel processing mechanism, which can be understood as, in response to the hardware device processes any one of the plurality of the buffer management request sets, for each stage of processing the buffer management request, a next buffer management request can only be processed after a current buffer management request is processed, and the multiple stages of processing the buffer management request cannot simultaneously process the same buffer management request, but the multiple stages of processing the buffer management request can simultaneously process different buffer management requests.

Step S14, storing relevant information of corresponding processing stages by using different storage queues in the plurality of storage queue sets.

In this embodiment, in a process of the hardware device processing a task, a request queue, a page index queue and a response queue in a storage queue set store relevant information of corresponding processing stages. After a storing process is completed, information saved in the response queue need to be processed. In some embodiments, judging whether the response queue is a non-empty queue; in response to the response queue is a non-empty queue, then generating a new interrupt flag; updating a preset interrupt flag register by using the new interrupt flag, so that, after a software program running in a central processing unit detects that an interrupt flag in the interrupt flag register is updated, obtaining response information corresponding to the new interrupt flag from the response queue, and performing corresponding processing based on the obtained response information; a software processor reads out the response information from the response queue, thereby obtaining a buffer indicated by a number of consecutive page indices.

In some embodiments, the request information stored in the request queue includes an operation type, a page index address or a buffer size, a page index quantity, and a user callback function address; the response information stored in the response queue includes an operation type, an operation state, a page index address, a page index quantity, and a user callback function address. Wherein, a purpose of that the request queue and the response queue respectively store callback function addresses corresponding to the respective processing stages is for determining a current degree of processing progress of a processing stage by utilizing the callback function address corresponding thereto. It can be understood that, during a process of processing any one of the buffer management requests, utilization of the callback function address makes it possible to process a next buffer management request without waiting for completion of processing of the current buffer management request, In some embodiments, while the current buffer management request is in a stage of requesting to acquire a buffer configuration, a request acquisition stage of the next buffer management request may be performed. Therefore, the callback function addresses enable asynchronous processing of buffer management requests in any one of the plurality of buffer management request sets by means of a pipeline parallel processing mechanism, and in response to a buffer management algorithm is running, a data transmission task would no longer be in an idle state of waiting for a buffer, which fully exploits multi-core parallel functionality of a processor and makes the whole process run in a unblocked manner, thereby improving the performance of the buffer management algorithm and increasing the speed of task processing.

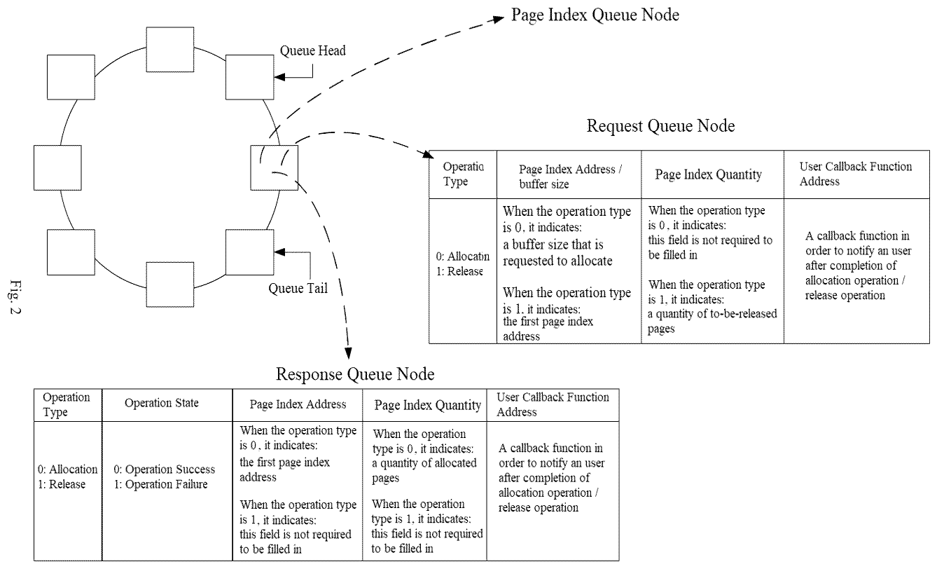

As shown in FIG. 2, a specific configuration of a storage queue and information saved therein is shown. In this embodiment, each type among the plurality of storage queues may be a circular queue. As shown in FIG. 2, the request queue, the page index queue and the response queue all adopt a circular structure for building respective queues. Wherein, a request queue contains a plurality of request nodes, one request node corresponds to one buffer management request, the request information stored in the request node includes an operation type, a page index address or a buffer size, a page index quantity and a user callback function address, wherein, in response to the operation type is 0, it indicates allocation, and in response to the operation type is 1, it indicates release, in some embodiments, in response to the operation type is 0, the field value of page index address or buffer size indicates a buffer size that is requested to allocate, and the field of page index quantity is not required to be filled in, and the user callback function address is used to notify an user of a determined current degree of processing progress of the request acquisition stage after completion of allocation operation; and in response to the operation type is 1, the field value of page index address or buffer size indicates the first page index address, the page index quantity indicates a quantity of to-be-released pages, the user callback function address is used to notify an user of a determined current degree of processing progress of the request acquisition stage after completion of release operation; and a response queue contains a plurality of response nodes, and the response information stored in the response node includes an operation type, an operation state, a page index address, a page index quantity, and a user callback function address, wherein, in response to the operation type is 0, it indicates allocation, and in response to the operation type is 1, it indicates release, furthermore, in response to the operation state is 0, it indicates operation success, and in response to the operation state is 1, it indicates operation failure, in some embodiments, in response to the operation type is 0, the field value of page index address indicates the first page index address, the page index quantity indicates a quantity of allocated pages, and the user callback function address is used to notify an user of a determined current degree of processing progress of the request response stage after completion of allocation operation; in response to the operation type is 1, the field of page index address is not required to be filled in, the field of page index quantity is also not required to be filled in, and the user callback function address is used to notify an user of a determined current degree of processing progress of the request response stage after completion of release operation. In addition, a queue head and a queue tail of the storage queue are hardware registers, which represent a read pointer and a write pointer of the storage queue, and the software configures the address and size information of all the queues into the hardware.

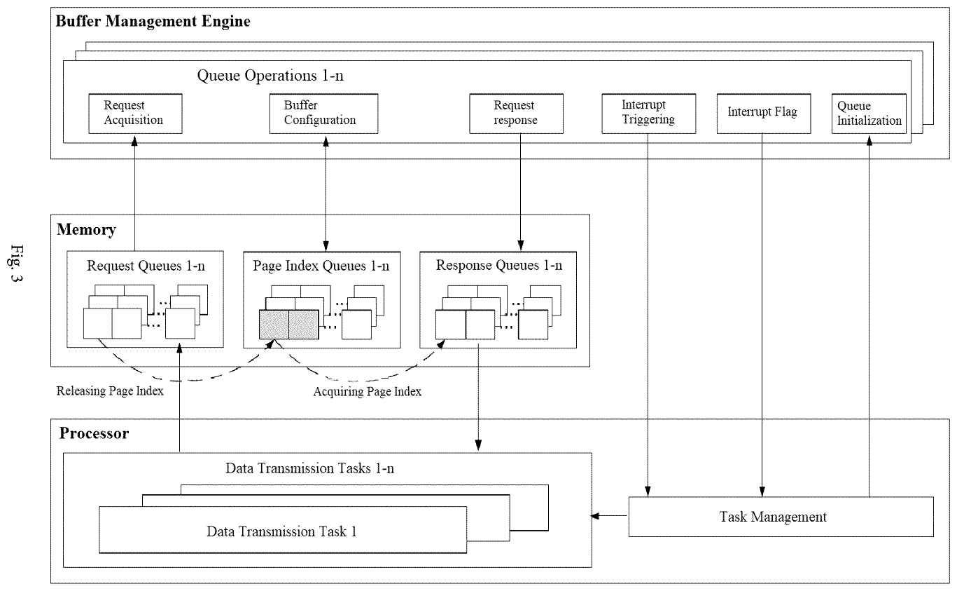

As shown in FIG. 3, a specific process of task processing is shown. First, a task management module in a processor creates a plurality of storage queue sets in the memory, wherein each of the plurality of storage queue sets includes a request queue, a response queue, and a page index queue. A queue initialization module of the hardware saves information of all the queues, and resets a queue head register and a queue tail register; any one of the data transmission tasks adds several request nodes into the request queue and updates the queue tail; afterwards, in response to a request acquisition module of the hardware detects a change of the queue tail of the request queue by polling, acquiring the request information from the queue, calculating a quantity of to-be-requested pages according to a buffer size that is requested to allocate, and updating the queue head of the request queue; a buffer configuration module of the hardware acquires a plurality of consecutive page indices as base addresses from the page index queue according to the aforesaid quantity of to-be-requested pages, and updates the queue head of the page index queue; a request response module of the hardware builds a response node according to the page indices as base addresses, the page index quantity, and the callback function address of the request node, and then adds the response node into the response queue and updates the queue tail of the response queue; the hardware updates an interrupt flag register according to whether a state of the response queue is a non-empty queue, and triggers an interrupt to notify a processor core for operating a management task by an interrupt triggering module; the task management task module in the processor queries an interrupt flag to identify the non-empty response queue, then notifies a data transmission task corresponding to the response queue by means of an inter-processor interrupt that there exists to-be-processed response information; this data transmission task in the processor reads out the response information from the response queue, so as to acquire a buffer indicated by the plurality of consecutive page indices, and after reading out each response node, a callback function address is extracted therefrom to continue with the previously uncompleted data transmission.

In addition, the process of buffer release is similar to the process of buffer allocation, the only difference is that, in the process of buffer release, the hardware reads out a plurality of consecutive page indices from information of each node of the request queue, and copies the plurality of consecutive page indices into the page index queue by means of a DMA mechanism.

It can be seen that, the present application acquires a plurality of to-be-processed tasks; wherein, the plurality of to-be-processed tasks respectively correspond to a plurality of buffer management request sets; creates different storage queues for storing relevant information of different processing stages in a request processing process for each of the plurality of buffer management request sets to obtain a plurality of storage queue sets respectively corresponding to the plurality of buffer management request sets; and processes the plurality of to-be-processed tasks in parallel by a hardware device with parallel execution functionality, and, in a process of processing any one of the plurality of buffer management request sets, processes different buffer management requests in the plurality of buffer management request sets based on a pipeline parallel processing mechanism, and stores relevant information of corresponding processing stages by using different storage queues in the plurality of storage queue sets. By means of the aforesaid technical solution, tasks are collaboratively processed by software and hardware, and most of the processing processes are completed by hardware, so that the use of software is decreased and a utilization rate of the processor is significantly reduced. In addition, the aforesaid technical solution uses a hardware device with parallel execution functionality to realize parallel processing of multiple tasks, and adopts a pipeline parallel processing mechanism to realize asynchronous processing of different buffer management requests in the plurality of buffer management request sets, thus improving the performance of a buffer management algorithm and increasing the speed of task processing.

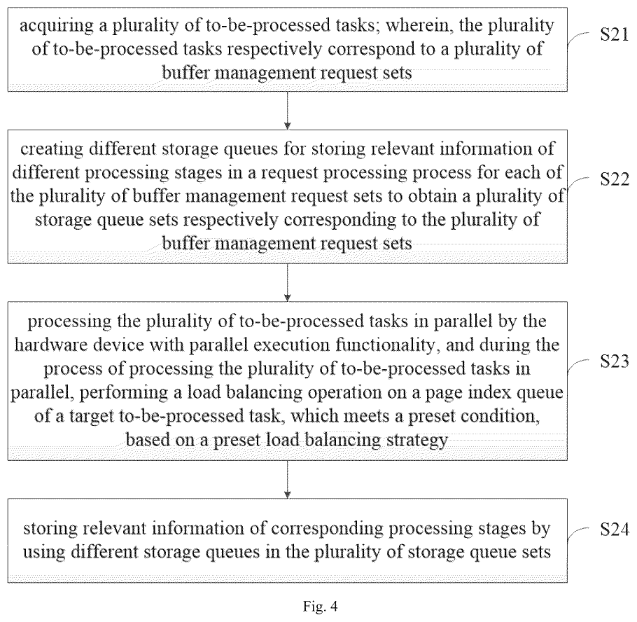

Referring to FIG. 4, an embodiment of the present application discloses a specific task processing method which includes:

Step S21: acquiring a plurality of to-be-processed tasks; wherein, the plurality of to-be-processed tasks respectively correspond to a plurality of buffer management request sets.

Wherein, a more detailed processing process of the step S21 can refer to relevant content disclosed in the aforesaid embodiments, so it is not repeatedly described herein.

Step S22: creating different storage queues for storing relevant information of different processing stages in a request processing process for each of the plurality of buffer management request sets to obtain a plurality of storage queue sets respectively corresponding to the plurality of buffer management request sets.

Wherein, a more detailed processing process of the step S22 can refer to relevant content disclosed in the aforesaid embodiments, so it is not repeatedly described herein.

Step S23: processing the plurality of to-be-processed tasks in parallel by the hardware device with parallel execution functionality, and during the process of processing the plurality of to-be-processed tasks in parallel, performing a load balancing operation on a page index queue of a target to-be-processed task, which meets a preset condition, based on a preset load balancing strategy.

In this embodiment, the hardware device can process the plurality of to-be-processed tasks in parallel for parallel processing, and load imbalance may occur, at this time, the load balancing operation is required to be performed on the page index queue of the target to-be-processed task, which meets the preset condition, based on a preset load balancing strategy. In some embodiments, monitoring a plurality of page index queues corresponding to the plurality of to-be-processed tasks to select a target page index queue with currently unbalanced load, and triggering a to-be-processed load balancing event for the target page index queue; monitoring whether there is currently a to-be-processed buffer configuration event for the target page index queue; in response to a to-be-processed buffer configuration event is currently detected, then, according to a preset priority determination strategy, determining a first priority corresponding to the to-be-processed load balancing event and a second priority corresponding to the to-be-processed buffer configuration event; in response to the first priority is higher than the second priority, performing a load balancing operation for the target page index queue, and then performing a buffer configuration operation for the target page index queue; in response to the first priority is lower than the second priority, performing a buffer configuration operation for the target page index queue, and then performing a load balancing operation for the target page index queue.

It can be understood that, the buffer configuration operation and the load balancing operation of the target page index queue cannot be performed simultaneously, therefore, in response to there is currently a to-be-processed load balancing event triggered for the target page index queue while a buffer configuration operation is being performed for the target page index queue, a feedback is executed according to a current state of the target page index queue, indicating that the load balancing operation cannot be performed temporarily.

In this embodiment, specific steps of performing a load balancing operation for the target page index queue are as follows, in response to a memory page usage state corresponding to the target page index queue is an oversaturated state, allocating a new memory page for the target page index queue by using a preset page index cache queue and according to a preset memory page allocation strategy; in response to the memory page usage state of the target page index queue is an idle state, then an idle memory page corresponding to the target page index queue is released according to a preset memory page release strategy to restore the idle memory page into the preset page index cache queue. It can be understood that, the aforesaid load balancing operation dynamically adjusts a length of the corresponding page index queue according to a buffer demand of the data transmission task, thereby improving the performance and flexibility of the buffer management algorithm.

It can be understood that, in order to perform the aforesaid load balancing operation, it is required to also create a page index cache queue while creating a page index queue for storing memory page index information relevant to the buffer configuration stage, in some embodiments, determining a first preset memory page allocation proportion and a second preset memory page allocation proportion; allocating a corresponding number of memory pages in a memory to a first queue according to the first preset memory page allocation proportion to obtain the preset page index cache queue, and allocating another corresponding number of memory pages in the memory to a second queue according to the second preset memory page allocation proportion to obtain the page index queue. Wherein, the first preset memory page allocation proportion may be represented as 20% of total memory pages, and the second preset memory page allocation proportion may be represented as 80% of total memory pages.

In some embodiments, the second queue represents a plurality of page index queues corresponding to a plurality of to-be-processed tasks, and allocating a corresponding number of memory pages to the second queue according to the second preset memory page allocation proportion is done by evenly allocating a corresponding number of memory pages to a plurality of page index queues according to the second preset memory page allocation proportion.

Step S24, storing relevant information of corresponding processing stages by using different storage queues in the plurality of storage queue sets.

In this embodiment, the steps of performing a buffer configuration operation for the target page index queue and performing a load balancing operation for the target page index queue both would change a state of the target page index queue, therefore, it is required to update a page index queue state after performing the buffer configuration operation and/or the load balancing operation.

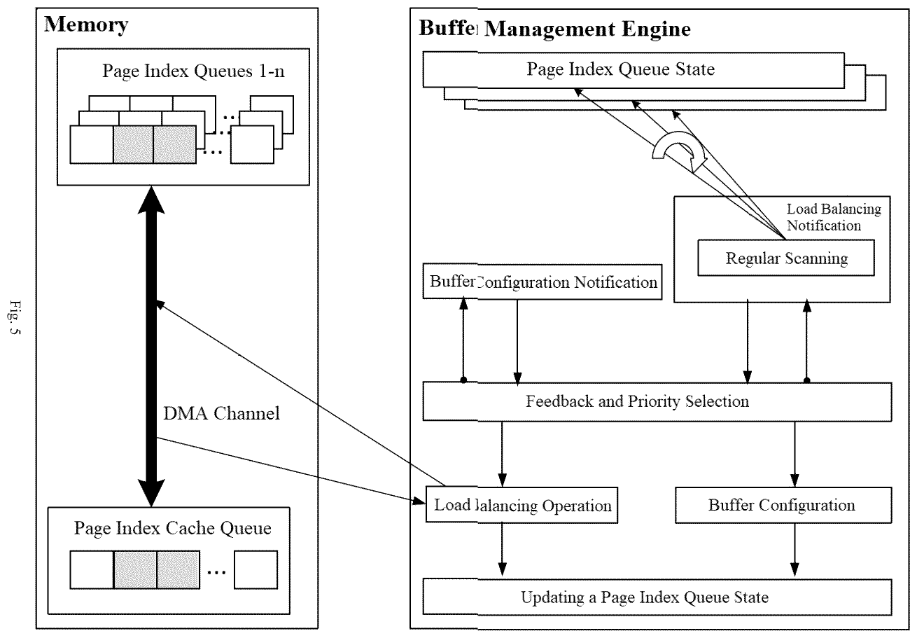

As shown in FIG. 5, steps of load balancing under the circumstances of multi-task processing are shown, specific content is as follows, first, allocating a plurality of memory pages to the page index cache queue in a software initialization stage according to a certain proportion, and allocating the rest of memory pages to all the page index queues, then configurating information of all the queues into hardware. A load balancing notification module of the hardware polls all page index queue states regularly, and in response to it is detected that a certain page index queue needs a load balancing operation to be performed thereon, then notifying a feedback and priority selection module; the feedback and priority selection module of the hardware receives operation notifications from both a buffer configuration notification module and the load balancing notification module, and gives a feedback according to a current page index queue state or selectively performs a load balancing operation or a buffer configuration operation according to a certain priority determination strategy; after a load balancing operation module of the hardware receives a notification, according to a current page index queue state, the load balancing operation module configures a DMA channel to move page indices between the page index cache queue and the page index queue; the load balancing operation module of the hardware updates the page index queue state after receiving a DMA completion signal. It can be understood that, the page index queue state also needs to be updated after a buffer configuration module of the hardware finishes execution of a buffer configuration operation.

It can be seen that, the present application acquires a plurality of to-be-processed tasks; wherein, the plurality of to-be-processed tasks respectively correspond to a plurality of buffer management request sets; creates different storage queues for storing relevant information of different processing stages in a request processing process for each of the plurality of buffer management request sets to obtain a plurality of storage queue sets respectively corresponding to the plurality of buffer management request sets; processes the plurality of to-be-processed tasks in parallel by the hardware device with parallel execution functionality, and, during the process of processing the plurality of to-be-processed tasks in parallel, performs a load balancing operation on a page index queue of a target to-be-processed task, which meets a preset condition, based on a preset load balancing strategy; finally, stores relevant information of corresponding processing stages by using different storage queues in the plurality of storage queue sets. In the aforesaid technical solution, the page index cache queue and the page index queue are utilized to dynamically adjust a length of the corresponding page index queue according to a buffer demand of the data transmission task, thereby finishing the load balancing operation to further improve the performance and flexibility of the buffer management algorithm.

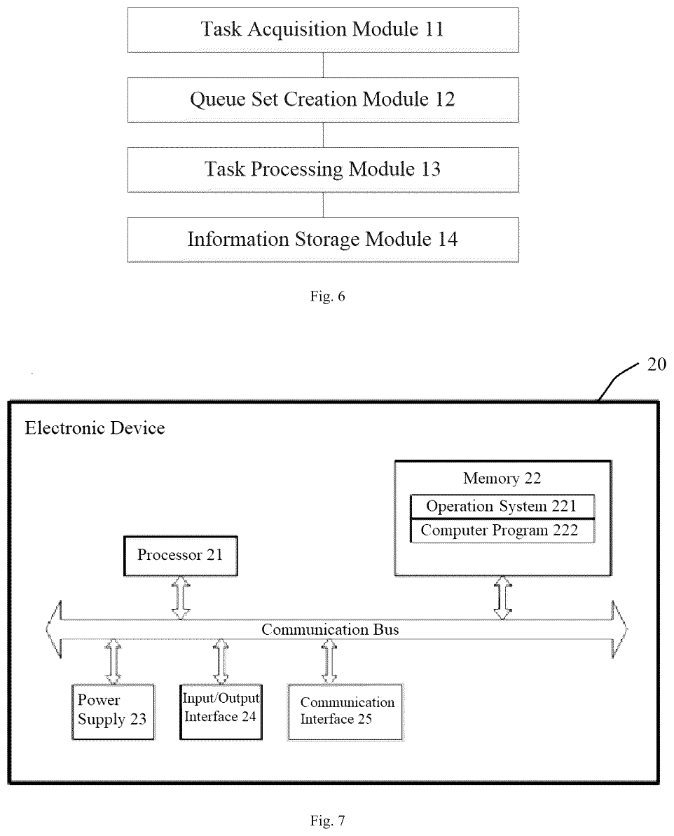

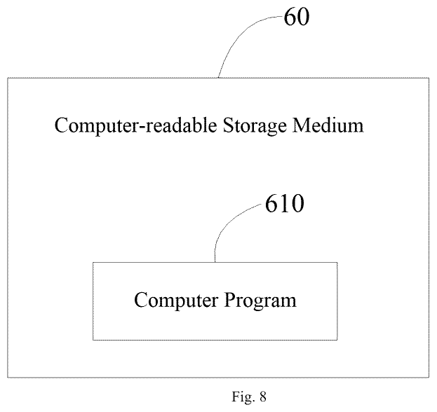

Referring to FIG. 6, an embodiment of the present application discloses a task processing apparatus which includes:
a task acquisition module 11, configured to acquire a plurality of to-be-processed tasks; wherein, the plurality of to-be-processed tasks respectively correspond to a plurality of buffer management request sets;
a queue set creation module 12, configured to create different storage queues for storing relevant information of different processing stages in a request processing process for each of the plurality of buffer management request sets to obtain a plurality of storage queue sets respectively corresponding to the plurality of buffer management request sets;
a task processing module 13, configured to process the plurality of to-be-processed tasks in parallel by a hardware device with parallel execution functionality, and, in a process of processing any one of the plurality of buffer management request sets, process different buffer management requests in the plurality of buffer management request sets based on a pipeline parallel processing mechanism;
an information storage module 14, configured to store relevant information of corresponding processing stages by using different storage queues in the plurality of storage queue sets.

Wherein, a more detailed operation process of the aforesaid respective modules can refer to relevant content disclosed in the aforesaid embodiments, so it is not repeatedly described herein.

It can be seen that, the present application acquires a plurality of to-be-processed tasks; wherein, the plurality of to-be-processed tasks respectively correspond to a plurality of buffer management request sets; creates different storage queues for storing relevant information of different processing stages in a request processing process for each of the plurality of buffer management request sets to obtain a plurality of storage queue sets respectively corresponding to the plurality of buffer management request sets; and processes the plurality of to-be-processed tasks in parallel by a hardware device with parallel execution functionality, and, in a process of processing any one of the plurality of buffer management request sets, processes different buffer management requests in the plurality of buffer management request sets based on a pipeline parallel processing mechanism, and stores relevant information of corresponding processing stages by using different storage queues in the plurality of storage queue sets. By means of the aforesaid technical solution, tasks are collaboratively processed by software and hardware, and most of the processing processes are completed by hardware, so that the use of software is decreased and a utilization rate of the processor is significantly reduced. In addition, the aforesaid technical solution uses a hardware device with parallel execution functionality to realize parallel processing of multiple tasks, and adopts a pipeline parallel processing mechanism to realize asynchronous processing of different buffer management requests in the plurality of buffer management request sets, thus improving the performance of a buffer management algorithm and increasing the speed of task processing.

In some embodiments, an embodiment of the present application also provides an electronic device 20 which may specifically include: at least a processor 21, at least a memory 22, a power supply 23, an input/output interface 24, a communication interface 25, and a communication bus 26. Wherein, the memory 22 is configured to store a computer program which can be loaded and executed by the processor 21 to perform relevant steps of the task processing method disclosed in any one of the aforesaid embodiments.

In this embodiment, the power supply 23 is configured to provide an working voltage for each of the hardware components of the electronic device 20; the communication interface 25 can establish a data transmission channel between the electronic device 20 and an external device, and a communication protocol followed by the communication interface 25 may be any communication protocol that can be applied to the technical solution of the present application, and is not specifically limited herein.

In addition, the memory 22 may include a random access memory as an internal operating memory and a non-transitory memory used for a storage purpose of an external memory, and resources stored thereon include an operation system 221, a computer program 222, etc., and a storage manner thereof may be temporary storing or persistent storing.

Wherein, the operation system 221 is configured to manage and control various hardware components and computer programs 222 on the electronic device 20 of a source host, and the operation system 221 may be Windows, Unix, Linux, etc. The computer program 222 may further include a computer program capable of performing other specific tasks, in addition to the computer program capable of performing the task processing method to be executed by the electronic device 20 as disclosed in any one of the aforesaid embodiments.

In this embodiment, the input/output interface 24 may specifically include, but not limited to, a USB interface, a hard disk reading interface, a serial interface, a voice input interface, a fingerprint input interface, etc.

In some embodiments, as shown in FIG. 8, an embodiment of the present application further discloses a computer-readable storage medium 60, which may include a Random Access Memory (RAM), an internal memory, a Read-Only Memory (ROM), an electric-programmable ROM, an electric-erasable programmable ROM, a register, a hard disk, a magnetic disk or an optical disk, or any other form of storage medium known in the art. Wherein, the computer program 610 stored therein, in response to executed by a processor, causes the processor to perform the aforesaid task processing method. Specific steps of the method can refer to corresponding contents disclosed in the aforesaid embodiments and will not be repeated herein.

Embodiments in this specification are described in a progressive manner with emphasis on the difference thereof from other embodiments, and the same or similar parts among the embodiments can refer to each other. As for the apparatus disclosed in the embodiments, since it corresponds to the task processing method disclosed in the aforesaid embodiments, the description thereof is relatively simple, and relevant parts thereof can refer to the method sections.

Steps of the task processing method described in connection with the embodiments disclosed herein may be implemented directly by hardware, by a software module executed by a processor, or by a combination of both. The software module may exist in a Random Access Memory (RAM), an internal memory, a Read-Only Memory (ROM), an electric-programmable ROM, an electric-erasable programmable ROM, a register, a hard disk, a removable disk, a CD-ROM, or any other form of storage medium known in the art.

Finally, it should also be noted that, relational terms such as “first” and “second” are used herein only to distinguish an entity or operation from another entity or operation, and do not necessarily require or imply any actual relation or order between these entities or operations. Moreover, the terms “comprising”, “including” or any other variation thereof are intended to encompass non-exclusive inclusion, so that a process, a method, an article, or a device that “comprises” a set of elements is construed to include not only those elements but also other elements that are not explicitly listed or are inherent to such a process, a method, an article or a device. In absence of further limitations, an element defined by a phrase “includes one . . . ” does not preclude the existence of another identical element in a process, a method, an article or a device in which said element is included.

Hereinabove, a task processing method and apparatus, a device, and a medium provided by the present application are described in detail. In this paper, the principle and implementation ways of the present application are expounded by illustrating specific embodiments. The description of the above embodiments is only intended to help understand the method of the present application and its core idea; meanwhile, for a person skilled in the art, according to the inventive concept of the present application, changes may be made based on the specific embodiments and the application scope thereof. In conclusion, contents of this specification shall not be understood as limitation to the present application.

1. A task processing method, comprising:
acquiring a plurality of to-be-processed tasks; wherein, the plurality of to-be-processed tasks respectively correspond to a plurality of buffer management request sets;
creating different storage queues for storing relevant information of different processing stages in a request processing process for each of the plurality of buffer management request sets to obtain a plurality of storage queue sets respectively corresponding to the plurality of buffer management request sets;
processing the plurality of to-be-processed tasks in parallel by a hardware device with parallel execution functionality, and in a process of processing any one of the plurality of buffer management request sets, processing different buffer management requests in the plurality of buffer management request sets based on a pipeline parallel processing mechanism, and storing relevant information of corresponding processing stages by using different storage queues in the plurality of storage queue sets.

2. The task processing method according to claim 1, wherein, the step of creating different storage queues for storing relevant information of different processing stages in a request processing process for each of the plurality of buffer management request sets to obtain a plurality of storage queue sets respectively corresponding to the plurality of buffer management request sets comprises:
for each buffer management request set, creating a request queue for storing request information corresponding to a request acquisition stage, a page index queue for storing memory page index information relevant to a buffer configuration stage, and a response queue for storing response information corresponding to a request response stage, respectively, in the request processing process, to obtain the plurality of storage queue sets respectively corresponding to the plurality of buffer management request sets.

3. The task processing method according to claim 2, wherein, after the step of processing different buffer management requests in the plurality of buffer management request sets based on a pipeline parallel processing mechanism, and storing relevant information of corresponding processing stages by using different storage queues in the plurality of storage queue sets, the method further comprises:
judging whether the response queue is a non-empty queue;
in response to the response queue is a non-empty queue, then generating a new interrupt flag;
updating a preset interrupt flag register by using the new interrupt flag, so that, after a software program running in a central processing unit detects that an interrupt flag in the interrupt flag register is updated, obtaining response information corresponding to the new interrupt flag from the response queue, and performing corresponding processing based on the obtained response information.

4. The task processing method according to claim 2, wherein, the step of processing the plurality of to-be-processed tasks in parallel by a hardware device with parallel execution functionality comprises:
processing the plurality of to-be-processed tasks in parallel by the hardware device with parallel execution functionality, and during the process of processing the plurality of to-be-processed tasks in parallel, performing a load balancing operation on a page index queue of a target to-be-processed task, which meets a preset condition, based on a preset load balancing strategy.

5. The task processing method according to claim 4, wherein, the step of performing a load balancing operation on a page index queue of a target to-be-processed task, which meets a preset condition, based on a preset load balancing strategy comprises:
monitoring a plurality of page index queues corresponding to the plurality of to-be-processed tasks to select a target page index queue with currently unbalanced load, and triggering a to-be-processed load balancing event for the target page index queue;
monitoring whether there is currently a to-be-processed buffer configuration event for the target page index queue;
in response to a to-be-processed buffer configuration event is currently detected, then, according to a preset priority determination strategy, determining a first priority corresponding to the to-be-processed load balancing event and a second priority corresponding to the to-be-processed buffer configuration event;
in response to the first priority is higher than the second priority, performing a load balancing operation for the target page index queue, and then performing a buffer configuration operation for the target page index queue;
in response to the first priority is lower than the second priority, performing a buffer configuration operation for the target page index queue, and then performing a load balancing operation for the target page index queue.

6. The task processing method according to claim 5, wherein, the step of performing a load balancing operation for the target page index queue comprises:
in response to a memory page usage state corresponding to the target page index queue is an oversaturated state, allocating a new memory page for the target page index queue by using a preset page index cache queue and according to a preset memory page allocation strategy;
in response to the memory page usage state of the target page index queue is an idle state, then an idle memory page corresponding to the target page index queue is released according to a preset memory page release strategy to restore the idle memory page into the preset page index cache queue;
and, the step of creating a page index queue for storing memory page index information relevant to a buffer configuration stage comprises:
determining a first preset memory page allocation proportion and a second preset memory page allocation proportion;
allocating a corresponding number of memory pages in a memory to a first queue according to the first preset memory page allocation proportion to obtain the preset page index cache queue, and allocating another corresponding number of memory pages in the memory to a second queue according to the second preset memory page allocation proportion to obtain the page index queue.

7. The task processing method according to claim 1, wherein, the step of storing relevant information of corresponding processing stages by using different storage queues in the plurality of storage queue sets comprises:
storing a callback function address corresponding to each of the respective processing stages by using different storage queues in the plurality of storage queue sets, for determining a current degree of processing progress of a processing stage by utilizing the callback function address corresponding thereto.

8. The task processing method according to claim 1, wherein, the plurality of to-be-processed tasks respectively correspond to a plurality of buffer management request sets in such a way that:
the plurality of to-be-processed tasks respectively correspond to the plurality of buffer management request sets in a one-to-one manner.

9. (canceled)

10. (canceled)

11. An electronic device, comprising a processor and a memory; wherein, the memory has a computer program stored therein, and the computer program, in response to executed by the processor, causes the processor to perform steps of a task processing method, the steps comprises:
acquiring a plurality of to-be-processed tasks; wherein, the plurality of to-be-processed tasks respectively correspond to a plurality of buffer management request sets;
creating different storage queues for storing relevant information of different processing stages in a request processing process for each of the plurality of buffer management request sets to obtain a plurality of storage queue sets respectively corresponding to the plurality of buffer management request sets;
processing the plurality of to-be-processed tasks in parallel by a hardware device with parallel execution functionality, and in a process of processing any one of the plurality of buffer management request sets, processing different buffer management requests in the plurality of buffer management request sets based on a pipeline parallel processing mechanism, and storing relevant information of corresponding processing stages by using different storage queues in the plurality of storage queue sets.

12. A non-transitory computer-readable storage medium, configured to store a computer program therein; wherein, the computer program, in response to executed by a processor, causes the processor to perform steps of a task processing method, the steps comprises:
acquiring a plurality of to-be-processed tasks; wherein, the plurality of to-be-processed tasks respectively correspond to a plurality of buffer management request sets;
creating different storage queues for storing relevant information of different processing stages in a request processing process for each of the plurality of buffer management request sets to obtain a plurality of storage queue sets respectively corresponding to the plurality of buffer management request sets;
processing the plurality of to-be-processed tasks in parallel by a hardware device with parallel execution functionality, and in a process of processing any one of the plurality of buffer management request sets, processing different buffer management requests in the plurality of buffer management request sets based on a pipeline parallel processing mechanism, and storing relevant information of corresponding processing stages by using different storage queues in the plurality of storage queue sets.

13. The task processing method according to claim 1, wherein, the buffer management requests include a buffer allocation request and a buffer release request.

14. The task processing method according to claim 1, wherein, after obtaining a plurality of storage queue sets respectively corresponding to the plurality of buffer management request sets, address and size information of all the queues are configured into hardware, and the hardware completes a process of processing the plurality of buffer management request sets corresponding to the plurality of to-be-processed tasks.

15. The task processing method according to claim 1, wherein, each of the plurality of to-be-request tasks corresponds to one of the plurality of buffer management request sets, and each of the plurality of buffer management request sets contains a plurality of buffer management requests.

16. The task processing method according to claim 3, wherein, the request information stored in the request queue includes an operation type, a page index address or a buffer size, a page index quantity, and a user callback function address; the response information stored in the response queue includes an operation type, an operation state, a page index address, a page index quantity, and a user callback function address.

17. The electronic device according to claim 11, wherein, the step of creating different storage queues for storing relevant information of different processing stages in a request processing process for each of the plurality of buffer management request sets to obtain a plurality of storage queue sets respectively corresponding to the plurality of buffer management request sets comprises:
for each buffer management request set, creating a request queue for storing request information corresponding to a request acquisition stage, a page index queue for storing memory page index information relevant to a buffer configuration stage, and a response queue for storing response information corresponding to a request response stage, respectively, in the request processing process, to obtain the plurality of storage queue sets respectively corresponding to the plurality of buffer management request sets.

18. The electronic device according to claim 17, wherein, the step of processing the plurality of to-be-processed tasks in parallel by a hardware device with parallel execution functionality comprises:
processing the plurality of to-be-processed tasks in parallel by the hardware device with parallel execution functionality, and during the process of processing the plurality of to-be-processed tasks in parallel, performing a load balancing operation on a page index queue of a target to-be-processed task, which meets a preset condition, based on a preset load balancing strategy.

19. The electronic device according to claim 18, wherein, the step of performing a load balancing operation on a page index queue of a target to-be-processed task, which meets a preset condition, based on a preset load balancing strategy comprises:
monitoring a plurality of page index queues corresponding to the plurality of to-be-processed tasks to select a target page index queue with currently unbalanced load, and triggering a to-be-processed load balancing event for the target page index queue;
monitoring whether there is currently a to-be-processed buffer configuration event for the target page index queue;
in response to a to-be-processed buffer configuration event is currently detected, then, according to a preset priority determination strategy, determining a first priority corresponding to the to-be-processed load balancing event and a second priority corresponding to the to-be-processed buffer configuration event;
in response to the first priority is higher than the second priority, performing a load balancing operation for the target page index queue, and then performing a buffer configuration operation for the target page index queue;
in response to the first priority is lower than the second priority, performing a buffer configuration operation for the target page index queue, and then performing a load balancing operation for the target page index queue.

20. The non-transitory computer-readable storage medium according to claim 12, wherein, the step of creating different storage queues for storing relevant information of different processing stages in a request processing process for each of the plurality of buffer management request sets to obtain a plurality of storage queue sets respectively corresponding to the plurality of buffer management request sets comprises:
for each buffer management request set, creating a request queue for storing request information corresponding to a request acquisition stage, a page index queue for storing memory page index information relevant to a buffer configuration stage, and a response queue for storing response information corresponding to a request response stage, respectively, in the request processing process, to obtain the plurality of storage queue sets respectively corresponding to the plurality of buffer management request sets.

21. The non-transitory computer-readable storage medium according to claim 20, wherein, the step of processing the plurality of to-be-processed tasks in parallel by a hardware device with parallel execution functionality comprises:
processing the plurality of to-be-processed tasks in parallel by the hardware device with parallel execution functionality, and during the process of processing the plurality of to-be-processed tasks in parallel, performing a load balancing operation on a page index queue of a target to-be-processed task, which meets a preset condition, based on a preset load balancing strategy.

22. The non-transitory computer-readable storage medium according to claim 21, wherein, the step of performing a load balancing operation on a page index queue of a target to-be-processed task, which meets a preset condition, based on a preset load balancing strategy comprises:
monitoring a plurality of page index queues corresponding to the plurality of to-be-processed tasks to select a target page index queue with currently unbalanced load, and triggering a to-be-processed load balancing event for the target page index queue;
monitoring whether there is currently a to-be-processed buffer configuration event for the target page index queue;
in response to a to-be-processed buffer configuration event is currently detected, then, according to a preset priority determination strategy, determining a first priority corresponding to the to-be-processed load balancing event and a second priority corresponding to the to-be-processed buffer configuration event;
in response to the first priority is higher than the second priority, performing a load balancing operation for the target page index queue, and then performing a buffer configuration operation for the target page index queue;
in response to the first priority is lower than the second priority, performing a buffer configuration operation for the target page index queue, and then performing a load balancing operation for the target page index queue.
